(19) United States
(12) Patent Application Publication
(10) Pub. No.: US 2017/0113777 A1
(43) Pub. Date: Apr. 27, 2017

(54) Structural Arrangement, Aircraft Or Spacecraft, And Method For Producing A Structural Arrangement

(71) Applicant: Airbus Defence and Space GmbH, Taufkirchen (DE)

(72) Inventor: Christoph Breu, Rohrdorf (DE)

(73) Assignee: Airbus Defence and Space GmbH, Taufkirchen (DE)

(21) Appl. No.: 15/297,507

(22) Filed: Oct. 19, 2016

(30) Foreign Application Priority Data
Oct. 22, 2015 (DE) 10 2015 220 642.4

(51) Int. Cl. B64C 1/12; B64C 1/40; B64G 1/66; B32B 15/20; B32B 7/08; B32B 7/12; B32B 15/08; B64C 1/06; B32B 3/28

(52) U.S. Cl. CPC B64C 1/12; B64C 1/069; B64C 1/40; B64G 1/66; B32B 3/28; B32B 7/08; B32B 7/12; B32B 15/08; B32B 15/20; B64C 2001/0072

(57) ABSTRACT

A structural arrangement for an aircraft or spacecraft, in particular a fuselage structural arrangement, is disclosed. The structural arrangement includes: a former; a metal skin; and a fibre composite layer which is uniformly structured in a direction running transversely to the former and is arranged between the former and the metal skin. Further, an aircraft or spacecraft having a fuselage which has such a structural arrangement, and a method for producing such a structural arrangement are disclosed.

### FIELD OF THE INVENTION

The present invention relates to a structural arrangement for an aircraft or spacecraft, in particular a fuselage structural arrangement, to an aircraft or spacecraft, and to a method for producing a structural arrangement.

Although applicable to any desired structures, the present invention and the problem on which it is based will be explained in greater detail in relation to an aircraft fuselage.

### BACKGROUND OF THE INVENTION

Aircraft fuselages exist in various forms. In particular for short-haul aircraft, aircraft fuselages are mostly provided with metal formers and stringers, which are connected to a metal outer skin. This construction is comparatively robust, tolerant to damage and easy to repair. Furthermore, the metal design provides effective lightning protection.

In particular for long-haul aircraft, modern aircraft fuselages having a fibre composite construction are provided. In this case, both stringers and formers as well as an outer skin, covering the stringers and/or formers, of a fibre composite material, in particular carbon-fibre-reinforced plastics material, can be provided. Such a structure is particularly weight-saving. For lightning protection, a woven fabric or net consisting of copper (copper mesh) integrated into the outer skin is conventionally provided in this case. For electrical potential equalisation, additional devices, for example in the form of a so-called ESN network, are provided inside the fuselage.

Further constructions, referred to as hybrid constructions, of aircraft fuselages comprise both metal structural elements and fibre composite structural elements. Such a hybrid construction is described, for example, in DE 10 2007 003 277 B4. This construction also has an outer skin made of a fibre composite material, into which a metal net or woven fabric (metal mesh) is integrated.

### BRIEF SUMMARY OF THE INVENTION

It is one of the ideas of the present invention is to provide an improved structural arrangement for an aircraft or spacecraft fuselage.

According to one aspect of the invention, there is provided:
a structural arrangement for an aircraft or spacecraft, in particular a fuselage structural arrangement, having: a former; a metal skin; and a fibre composite layer which is uniformly structured in a direction running transversely to the former and is arranged between the former and the metal skin
an aircraft or spacecraft having a fuselage which has a structural arrangement according to the invention
a method for producing a structural arrangement, in particular a structural arrangement according to the invention, having the following method steps: providing a former, a metal skin and a uniformly structured fibre composite layer; orienting the fibre composite layer relative to the former in such a manner that it is arranged so that it is structured in a direction transverse to the former; fixing the fibre composite layer to the former; and fixing the metal skin to the fibre composite layer.

One of the ideas of the present invention lies in providing a load-bearing structure in the longitudinal direction of an aircraft fuselage which does not have any stringers but has a continuous fibre composite layer structured in the longitudinal direction, and providing this fibre composite layer with a metal skin.

The fibre composite layer can advantageously be formed or designed so that it is adapted to the loads that are to be received, in particular without having to take into consideration so-called impact requirements, that is to say irregular external loads such as those that occur, for example, in the case of impact from stones. The metal skin, on the other hand, can be formed for such impact requirements, that is to say, for example, so as to have high ductility, and at the same time for optimum lightning protection, without having to take into consideration the conventional fuselage loads, which are borne by the fibre composite layer and the former.

According to an embodiment of the invention there is thus provided a novel hybrid construction which, in a synergistic manner, permits a robust fuselage structural arrangement having high damage tolerance and at the same time a similar weight advantage to a pure fibre composite construction. Moreover, the requirements of a fuselage arrangement in terms of lightning protection and electrical potential equalisation are ensured according to an embodiment of the invention.

In addition, the outlay in terms of construction which is conventionally necessary for a plurality of individual formers is eliminated according to an embodiment of the invention. Instead, a large fibre composite layer can be used, which can be produced with a significantly lower outlay. A cost advantage is thus obtained according to an embodiment of the invention.

In particular, the fibre composite layer according to an embodiment of the invention advantageously requires a smaller installation height than is conventional in the case of stringers, and therefore additional usable peripheral installation space is freed. Moreover, the structuring of the fibre composite structure in the longitudinal direction in particular opens up already integrated channels, which can be used for cables and/or ventilation and/or for active insulation of the fuselage. An aircraft or spacecraft comprising such a fuselage can thus be constructed in a novel manner having an improved package.

Improved recyclability is further provided according to an embodiment of the invention, since it is easier to separate the metal skin from the fibre composite layer than to separate an integrated copper mesh of a fibre composite skin from the fibre material. It is accordingly significantly easier, for example, to reuse the fibres after pyrolysis.

The former is in particular a load-bearing component of a fuselage which receives loads in the peripheral direction of a fuselage, or transversely to the longitudinal direction. Alternatively, however, it would also be conceivable to receive loads in the peripheral direction, or transversely to the longitudinal direction, by means of the fibre composite layer and to receive loads in the longitudinal direction by means of such a load-bearing component. In connection with the present invention, the term “former” is thus to be understood generally as meaning a load-bearing component for strengthening a structural arrangement, in particular a fuselage, irrespective of the orientation. It would therefore also be conceivable in particular to replace the formers in an aircraft fuselage with the fibre composite layer instead of the stringers.

The fibre composite layer and the metal skin may extend over a large area of the former, the former in particular determining the shape of the structural arrangement.

According to a further development, the fibre composite layer has a shape which repeats periodically in cross section, in particular a corrugated sheet structure or a trapezoidal sheet structure. Accordingly, a structuring is advantageously created which is simple to produce and performs a load-bearing function in its orientation. A corrugated sheet is to be understood as being a sheet which is periodically wavy in cross section. A trapezoidal sheet is to be understood as being a sheet which is bent periodically, in particular bent at an angle, four times.

According to one embodiment, the metal skin covers the fibre composite layer completely. Advantageously, the load-bearing fibre composite layer is therefore completely protected by the metal skin from impact scenarios and can therefore be designed for regular loads. Furthermore, an additional lightning arrester is thus advantageously not required.

According to an advantageous embodiment, the metal skin is made from a ductile and/or conductive metal. Accordingly, the metal skin advantageously has increased damage tolerance as well as good lightning protection properties. For example, a ductile and conductive material can be aluminium.

According to one embodiment, the fibre composite layer is fixed to the former and/or the metal skin at regular intervals. In particular, the fibre composite layer is fixed to the former at those portions of its structuring that are in direct contact with the former. In the case of a corrugated sheet structure, those portions are, for example, the periodically repeating inside peaks of the corrugated sheet.

According to one embodiment, the fibre composite layer has a thermoplastic cover layer at least locally. The fibre composite layer can thus be connected to the metal skin and/or the former in a simple manner by thermoplastic welding. Alternatively or in addition, the former and/or the metal skin can also have a thermoplastic cover layer at least locally. The thermoplastic cover layer can be applied to the surface as a thermoplastic film during production of the fibre composite layer and thus welded or fused to the fibre composite layer during the curing process. The thermoplastic film can in particular be applied during the curing process. This is also possible in an analogous manner for a former produced having a fibre composite construction. Furthermore, the metal skin can also be coated at least locally with a thermoplastic layer, likewise by applying a film to its surface and subjecting the metal skin to heat treatment above a glass transition temperature of the thermoplastic film. The surface of the metal skin can also be correspondingly prepared for that purpose, for example having roughening or structuring, so that the thermoplastic material adheres well thereto. Alternatively, it would also be conceivable to apply the thermoplastic cover layer in each case in a liquid state in the manner of a paint.

According to a development, the fibre composite layer is accordingly thermoplastically welded to the former. Alternatively or in addition, the fibre composite layer can accordingly also be thermoplastically welded to the metal skin. Thermoplastic welding can be carried out, for example, by means of laser beam welding or ultrasonic welding. Accordingly, a connecting technique for producing the structural arrangement which is simple and quick to carry out is advantageously provided.

According to an embodiment, a clip supporting the former is thermoplastically welded to the former and/or the fibre composite layer. Accordingly, a connecting technique for fixing a clip which is simple and quick to carry out is advantageously also provided. The clip is formed in particular having a foot portion fixed to the fibre composite layer and a supporting portion fixed to the former. The clip thus prevents the former from tipping.

According to a further embodiment, the fibre composite layer is glued and/or riveted to the former and/or to the metal skin. Combinations of a thermoplastically welded and glued and/or riveted connection are also conceivable. For example, a combination of a thermoplastically welded and additionally, in particular partially, riveted connection or a combination of a connection which is thermoplastically welded and locally additionally glued, for example in regions that are difficult to access, would be conceivable. The metal skin may be connected to the fibre composite layer in such a manner that the metal skin is protected against contact corrosion.

According to an embodiment, holding means for fixing purposes are provided between the fibre composite layer and the metal skin. In particular, these holding means can on one side be adapted to the contour of the fibre composite layer and on the other side can provide a flat support for the metal skin or a support which is formed so as to be slightly curved by the curvature of the structural arrangement provided by the former. The skin can thus advantageously be fixed securely to the fibre composite layer. For example, the holding means can be wedge-like and arranged in the region of an outside peak of the corrugated sheet structure of the fibre composite layer on the left and right of the peak.

According to a development, the holding means are formed to compensate for different thermal expansions. The structural arrangement can thus advantageously be used in very different temperature conditions. For example, the holding means can to that end contain a flexible material. In particular, it can additionally be a thermoplastic material or a material coated with a thermoplastic cover layer. The holding means can thus advantageously be fixed directly in a single process step when the skin is fixed to the fibre composite layer by means of thermoplastic welding.

According to an embodiment of an aircraft or spacecraft, the fuselage has at least two formers, the structural arrangement continuing from former to former. The structural arrangement according to the invention can thus advantageously be used along the entire fuselage of the aircraft or spacecraft.

According to a method according to an aspect of the invention, the fibre composite layer and/or the former and/or the metal skin have a thermoplastic cover layer at least locally. Fixing is thereby carried out at least in part by means of thermoplastic welding. Advantageously, this represents a connecting technique which is simple and quick to carry out. In this case, a combination of thermoplastic welding with gluing and/or riveting for fixing is possible.

The above embodiments and developments can, where expedient, be combined with one another as desired. In particular, features of the structural arrangement can be applied to the method for producing a structural arrangement and vice versa.

Further possible embodiments, developments and implementations of the invention include combinations of features of the invention which are described above or below in connection with the embodiments, even if those combinations are not mentioned explicitly. In particular, a person skilled in the art will also add individual aspects as improvements or additions to each basic form of the present invention.

### BRIEF DESCRIPTION OF THE DRAWINGS

The invention will be explained in greater detail in the following on the basis of embodiments, with reference to the accompanying figures of the drawing. The elements of the drawings are not necessarily shown true to scale relative to one another.

In the figures:

FIG. 1 is a perspective view of a structural arrangement according to the invention;

FIG. 2 is a schematic sectional view of a structural arrangement in the region of a clip according to a first embodiment;

FIG. 3 is a schematic sectional view of a structural arrangement in the region of a clip according to a second embodiment;

FIG. 4 is a perspective view of a structural arrangement together with a holding means shown schematically;

FIG. 5 is a schematic cross section of a fibre composite layer;

FIG. 6 is a schematic cross section of a fibre composite layer according to a further embodiment; and

FIG. 7 is a schematic view of a portion of a fuselage of an aircraft or spacecraft.

In the figures, the same reference numerals denote components which are the same or have the same function, unless indicated otherwise.

### DETAILED DESCRIPTION

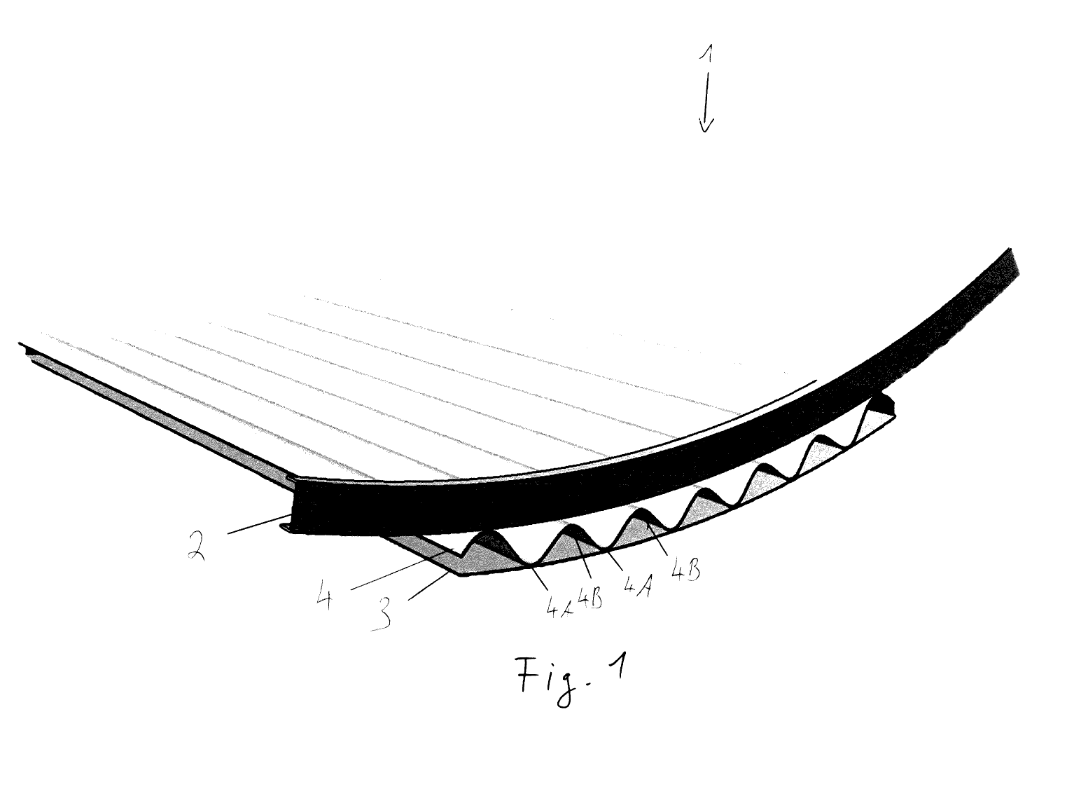

FIG. 1 is a perspective view of a structural arrangement 1 according to an embodiment of the invention.

The structural arrangement 1 is a fuselage structural arrangement for an aircraft or spacecraft. It has a former 2, a metal skin 3 and a fibre composite layer 4.

The fibre composite layer 4 has a corrugated sheet structure which runs transversely to the former 2 and has periodically alternating outside and inside peaks 4A, 4B. The fibre composite layer 4 is thus uniformly structured in a direction running transversely to the former 2.

In this case, the fibre composite layer 4 is arranged between the former 2 and the metal skin 3. Furthermore, the fibre composite layer 4 is covered completely by the metal skin 3 on an outer side. In this case, the metal skin 3 is fixed to the fibre composite layer 4 at each of the outside peaks 4A of the corrugated sheet structure.

On the inner side, the fibre composite layer 4 is fixed to the former 2 by its inside peaks 4B which are offset relative to the outside peaks 4A.

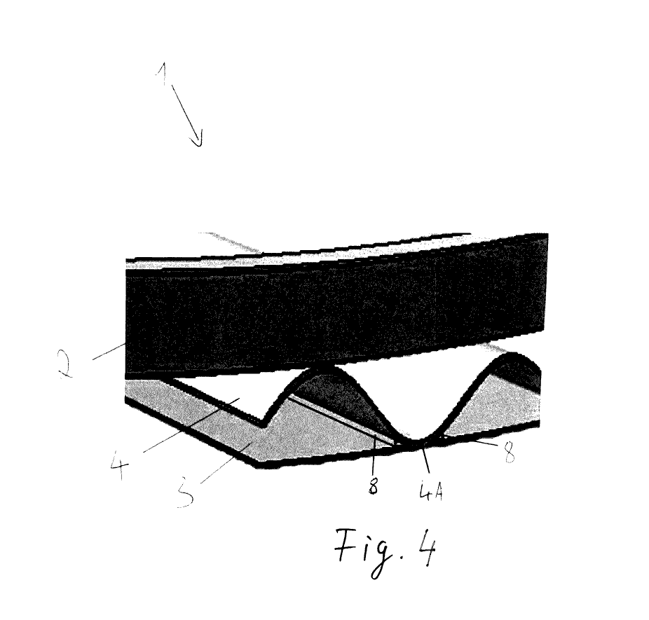

Fixing is in each case carried out by means of thermoplastic welding. To that end, the fibre composite layer 4 has a thermoplastic cover layer, which will be discussed in greater detail in relation to FIG. 4. Alternatively or in addition, the former 2 and/or the skin 3 can also have a thermoplastic cover layer. Furthermore, fixing can be produced, alternatively or in addition, by means of gluing or riveting.

By way of example, in the figure, the former 2 has a U-profile. However, other designs of the former, for example having a T-profile or double T-profile (also called an I-profile), are likewise possible.

The metal skin 3 is made from a metal sheet. In this case, the metal is a ductile and conductive metal. For example, the metal skin can be in the form of an aluminium sheet. A plurality of mutually adjacent metal sheets can also be provided.

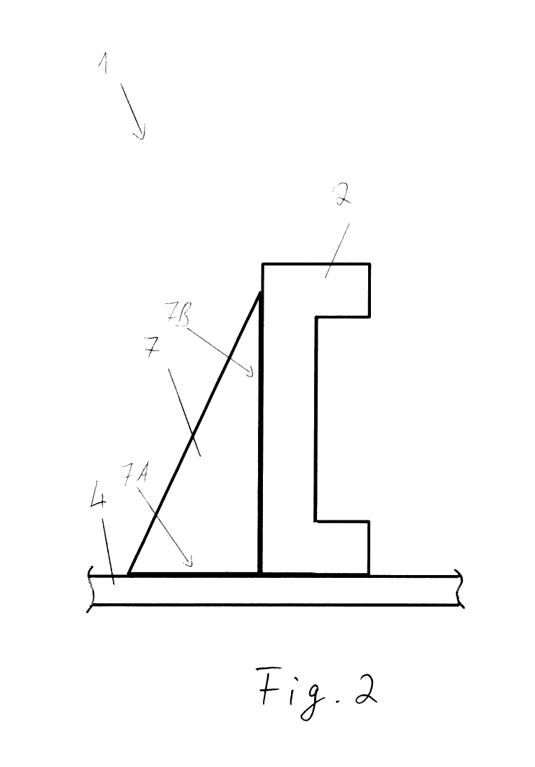

FIG. 2 is a schematic sectional view of a structural arrangement 1 in the region of a clip 7 according to a first embodiment.

The sectional plane shown runs along an inside peak 4B of the fibre composite layer 4. Visible edges and the metal skin 3 are not shown in the figure for the sake of clarity.

The clip 7 has a foot region 7A and a supporting region 7B. It is arranged in a joint region of the former 2 and the fibre composite layer 4 and serves to prevent the former 2 from tipping.

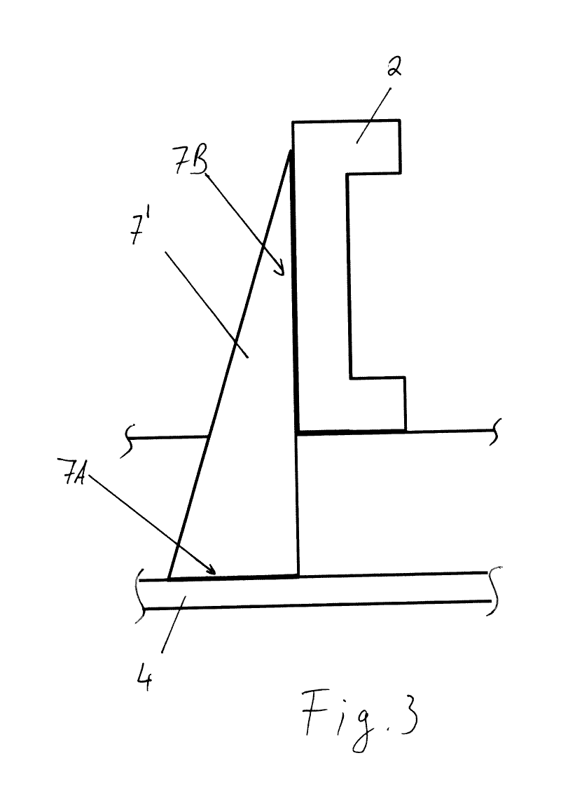

FIG. 3 is a schematic sectional view of a structural arrangement in the region of a clip 7′ according to a second embodiment.

In contrast to the first embodiment according to FIG. 2, the sectional plane here runs along an outside peak 4A.

A visible edge of the next inside peak 4B is shown partially concealed by the clip 7′.

Accordingly, the clip 7′ is in this case provided in the region of the outside peak 4A and extends by its foot region 7A as far as the outside peak 4A, bridging a gap between the former 2 and the outside peak 4A.

Here too, the clip 7′ serves to prevent the former 2 from tipping.

FIG. 4 is a perspective view of a structural arrangement 1 together with a holding means 8 shown schematically.

Purely by way of example, the holding means 8 is here in the form of a thermoplastic wedge provided on the left and right of each outside peak 4B of the corrugated sheet structure of the fibre composite layer 4.

Alternative forms of the holding means 8 can be configured in various ways and fixed to the skin 3 or the fibre composite layer 4. For example, the holding means can be a metal holding means which is provided only locally and does not extend continuously in the longitudinal direction.

The holding means is inserted into the gap between the fibre composite layer and the skin 3 on the left and right of the outside peak 4B before or during the fixing of the skin 3 to the fibre composite structure, for example. The holding means 8 then provides an enlarged support surface for the metal skin 3.

When the skin 3 is fixed to the fibre composite layer 4 by means of thermoplastic welding, the holding means 8 is at the same time fixed to the skin 3 and the fibre composite layer 4. Alternatively or in addition, the holding means 8 can also be fixed by gluing or riveting.

The holding means 8 is formed to compensate for different thermal expansions of the metal skin 3 and the fibre composite layer 4. For example, the holding means 8 is to that end formed of a resilient thermoplastic material. For example, this can be a so-called thermoplastic elastomer (TPE).

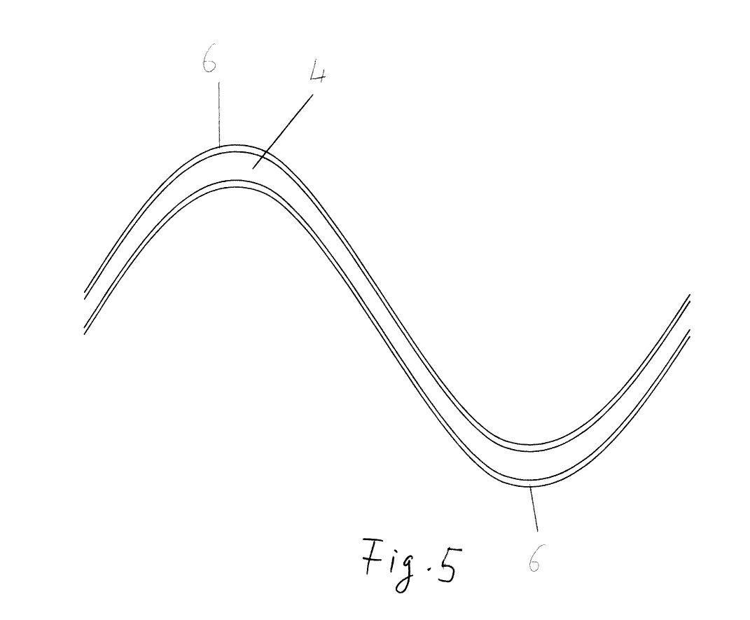

FIG. 5 is a schematic cross section of a fibre composite layer 4.

The fibre composite layer is formed having a structure which repeats periodically in cross section, by way of example here a corrugated sheet structure which is sinusoidal in cross section. The fibre composite layer 4 has a thermoplastic cover layer 6 both on its inner side and on its outer side.

The thermoplastic cover layer is applied in the form of a thermoplastic film during the production of the fibre composite layer 4, in particular in a curing operation.

Merely by way of example, the thermoplastic cover layer 6 is here provided continuously on both sides of the fibre composite layer 4. Alternatively, it would also be conceivable to provide the thermoplastic cover layer only on one side and/or only locally. To that end, the thermoplastic cover layer 6 can in particular be applied in a manner dependent on the welding zones provided. For example, the thermoplastic cover layer 6 can to that end be provided only in the regions of the inside and/or outside peaks.

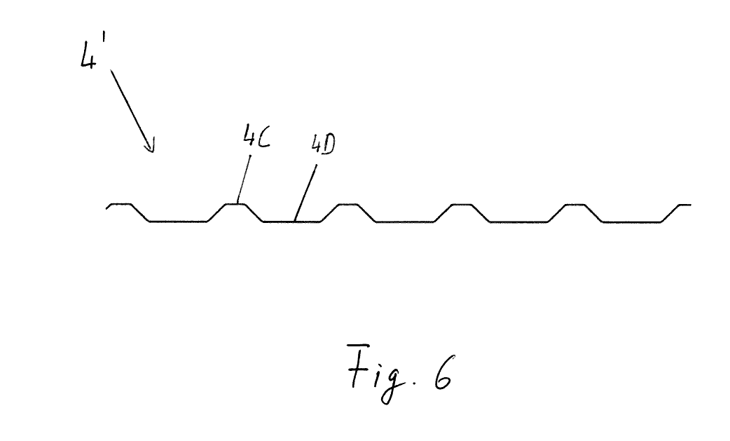

FIG. 6 is a schematic cross section of a fibre composite layer 4′ according to a further embodiment.

The fibre composite layer 4′ shown in this figure differs from the fibre composite layer 4 according to FIG. 5 on account of its trapezoidal structuring. It is accordingly a trapezoidal sheet which in cross section is bent at an angle four times in a periodically repeating manner.

Accordingly, the inside and outside peaks 4C, 4D each have a flat planar portion. The width of the planar portion can in each case be adapted to the desired width of a joining zone with the former 2 or with the skin 3. Therefore, when the fibre composite layer 4′ is designed in this manner, in particular no or fewer holding means are advantageously necessary. A thermoplastic cover layer 6 as in the embodiment according to FIG. 5 can likewise be provided.

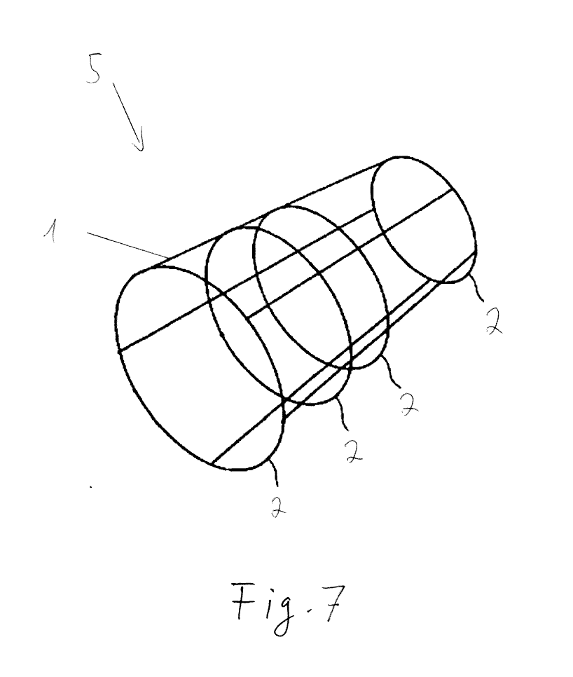

FIG. 7 is a schematic view of a portion of a fuselage 5 of an aircraft or spacecraft.

The fuselage 5 is formed having a structural arrangement 1 according to the invention, which is not shown in detail in the figure for the sake of clarity.

The fuselage 5 has a plurality of formers 2 which ensure mechanical stability in the peripheral direction and establish the outer shape of the fuselage 5. Purely by way of example, a total of four formers 2 are shown here. Depending on the length and design of the fuselage, a plurality of formers 2 adapted thereto can be provided.

The structural arrangement 1 thereby runs from former to former. This means each of the formers 2 is fixed to the fibre composite layer 4 (not shown in detail here) of the structural arrangement 1. The fibre composite layer 4 thereby ensures the stability of the fuselage 5 in the longitudinal direction.

Furthermore, the metal skin 3 (not shown in detail here) extends externally over the entire fuselage 5. Its function is to ensure that impact requirements are met and to provide lightning protection and electrical potential equalisation.

Although the present invention has been described by means of embodiments, it is not limited thereto but can be modified in various ways.

For example, in addition to a corrugated sheet structure, the fibre composite layer 4 can also be structured in a wide variety of different ways. For example, it can have a repeating rectangular or cap profile. Instead of the inside and outside peaks 4A, 4B, inner and outer planar surfaces would accordingly be provided. Cross-sectional forms having periodically repeating round and angular portions would further be conceivable, for example a sheet with rounded grooves introduced at regular intervals.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A structural arrangement for an aircraft or spacecraft, comprising:
a former;
a metal skin; and
a fibre composite layer uniformly structured in a direction running transversely to the former and arranged between the former and the metal skin.

2. The structural arrangement according to claim 1, wherein the fibre composite layer has in cross section a shape which repeats periodically.

3. The structural arrangement according to claim 2, wherein the fibre composite layer has in cross section a shape of a corrugated sheet structure or a trapezoidal sheet structure.

4. The structural arrangement according to claim 1, wherein the metal skin covers the fibre composite layer completely.

5. The structural arrangement according to claim 1, wherein the metal skin is made from a metal being at least one of ductile and conductive.

6. The structural arrangement according to claim 1, wherein the fibre composite layer is fixed to at least one of the former and to the metal skin at regular intervals.

7. The structural arrangement according to claim 1, wherein at least one of the fibre composite layer, the former, and the metal skin has a thermoplastic cover layer at least locally.

8. The structural arrangement according to claim 7, wherein the fibre composite layer is thermoplastically welded to at least one of the former and the metal skin.

9. The structural arrangement according to claim 7, wherein a clip supporting the former is thermoplastically welded to at least one of the former and the fibre composite layer.

10. The structural arrangement according to claim 7, wherein the fibre composite layer is glued to at least one of the former and the metal skin.

11. The structural arrangement according to claim 7, wherein the fibre composite layer is riveted to at least one of the former and the metal skin.

12. The structural arrangement according to claim 7, wherein holding means for fixing purposes are provided between the fibre composite layer and the metal skin.

13. The structural arrangement according to claim 12, wherein the holding means are formed to compensate for different thermal expansions.

14. The structural arrangement according to claim 1, wherein the structural arrangement is a fuselage structural arrangement.

15. An aircraft or spacecraft having a fuselage which comprises a structural arrangement comprising:
a former;
a metal skin; and
a fibre composite layer uniformly structured in a direction running transversely to the former and arranged between the former and the metal skin.

16. The aircraft or spacecraft according to claim 15, wherein the fuselage has at least two formers, the structural arrangement continuing from former to former.

17. A method for producing a structural arrangement, the method comprising:
providing a former, a metal skin and a uniformly structured fibre composite layer;
orienting the fibre composite layer relative to the former in such a manner that the fibre composite layer is arranged so that the fibre composite layer is structured in a direction transverse to the former;
fixing the fibre composite layer to the former; and
fixing the metal skin to the fibre composite layer.

18. The method according to claim 17, wherein at least one of the fibre composite layer, the former, and the metal skin at least locally comprises a thermoplastic cover layer and fixing is carried out at least in part by means of thermoplastic welding.
